(19) United States
(12) Patent Application Publication
(10) Pub. No.: US 2016/0170223 A1
(43) Pub. Date: Jun. 16, 2016

(54) METHOD AND APPARATUS FOR STEREOSCOPIC VIEWING

(71) Applicant: Russell Drew LEDERMAN, Berlin, MD (US)

(72) Inventor: Russell Drew LEDERMAN, Berlin, MD (US)

(21) Appl. No.: 14/968,809

(22) Filed: Dec. 14, 2015

Related U.S. Application Data
(60) Provisional application No. 62/124,210, filed on Dec. 12, 2014.

(51) Int. Cl. G02B 27/22; G02B 23/00; G02B 25/00

(52) U.S. Cl. CPC G02B 27/2242; G02B 27/2221; G02B 27/2214; G02B 25/001; G02B 23/00

(57) ABSTRACT

A stereoscopic viewing apparatus comprises a left eyepiece corresponding to a left light path for viewing by a left eye, and right eyepiece corresponding to a right eye path for viewing by a right eye. At least one light-shifting device is positioned in at least one of the left light path or the right light path, wherein the at least one light-shifting device displaces light incident on at least one of the left eye or the right eye, thereby creating a spectacular 3D enhancement when viewing very distant objects.

### CROSS REFERENCE TO RELATED APPLICATIONS

This application claims the benefit of U.S. Provisional Application No. 62/124,210, filed Dec. 12, 2014.

### BACKGROUND

1. Field of the Invention

The invention generally relates to stereoscopic viewing, and more particularly to method and apparatus for stereoscopic viewing.

2. Related Art

Many optical devices, use biocular viewing, or, viewing using both the left eye and the right eye simultaneously, for eye comfort and enhancing the experience of the viewer. Binocular devices, such as portable binocular telescopes, popularly called binoculars, are designed to provide biocular viewing, i.e., simultaneous viewing for the left and the right eye. For monocular devices like telescopes or microscopes with single objective lens(es) and/or mirror(s), biocular attachments use mirrored or duplicated images to provide biocular viewing for the left eye and the right eye.

When viewing objects that are at great distances, the light entering in both eyes (left eye and right eye) of a viewer through the left and right eyepieces, respectively, is identical or nearly identical. In such a scenario, also described as a scenario in which the object lies at ‘infinity’, the eyes do not perceive the depth dimension of the object being viewed, or the depth with respect to the object's surroundings, and instead perceive a two dimensional image of the object, as illustrated in FIGS. 1 and 2. Objects being at ‘infinity’ in the context of optical devices refers to objects that are too far away for the viewer to be able to perceive depth of the object, and in such scenarios, the light entering both the eyes of the viewer is theorized to be composed of parallel light rays, for example, as shown in FIGS. 1 and 2. For this reason, the light entering both the eyes of a viewer are identical, or at least, the variation in the light entering both the eyes is imperceptible for the human eye and/or brain. In other words, all of the respective positions of all objects within the field of view of each of right and left eyepieces are in the same position.

Similarly, an object drawn or printed on a planar surface appears as a two-dimensional object, or an object having very low depth may appear as a two-dimensional object, if the depth of the object is too low. In such cases, the viewer cannot perceive the depth of such an object because the depth is too low, even though the object itself may be relatively nearby.

Viewing objects in three dimensions, that is, the ability to perceive depth of an object is more preferable and attractive compared to viewing an object in two dimensions, when the depth of the object is not perceived. Accordingly, there exists a need for method and apparatus for stereoscopic viewing.

### SUMMARY

According to an embodiment, a stereoscopic viewing apparatus comprises a left eyepiece corresponding to a left light path for viewing by a left eye, and right eyepiece corresponding to a right eye path for viewing by a right eye. The at least one light-shifting device is positioned in at least one of the left light path or the right light path, wherein the at least one light-shifting device displaces light incident on at least one of the left eye or the right eye.

According to an embodiment, a method of retrofitting a biocular optical device with a stereoscopic viewing apparatus comprises positioning at least one light-shifting device in at least one of a left light path or a right light path corresponding to a left eyepiece or a right eyepiece, respectively. The at least one light-shifting device displaces light passing through at least one of the left eyepiece or the right eyepiece.

### BRIEF DESCRIPTION OF DRAWINGS

The accompanying drawings incorporated herein form a part of this specification, and illustrate the embodiments described herein. The drawings are merely illustrative and not intended to limit the embodiments described herein.

FIGS. 1 and 2 illustrate a conventional optical device for viewing an object;

FIGS. 3 and 4 illustrate an optical device for viewing an object stereoscopically, using a stereoscopic viewing apparatus, according to embodiments of the invention;

FIG. 5 illustrates a light shifting device and an eyepiece, according to embodiments of the invention;

FIGS. 6A-D illustrate modification of light path corresponding to two eyepieces in a biocular device arrangement of FIGS. 3 and 4, according to embodiments of the invention; and

FIGS. 7A and 7B illustrate a modified erfler eyepiece retrofitted with a light-shifting device, according to embodiments of the invention.

### DETAILED DESCRIPTION

Embodiments of the invention provide method and apparatus for stereoscopic viewing, and more specifically, creating a perception of depth or a three-dimensional view in scenarios in which only a two-dimensional view of an object of interest has been conventionally possible. Embodiments described herein utilize the theory, known to those familiar with the art of depth perception, that the difference in position of objects within a field of view perceived by a left eye and a right eye of a viewer, is used by the viewer's brain to create a perception of depth, resulting in the perception of three-dimensions. The difference in position of objects is substantially in a horizontal direction, and the quantum of the difference in the position depends on several factors including the depth of the object, type of optical devices, a viewer's eye and brain biology, among other factors. However, the embodiments described herein are not limited by such theory of either the brain's processing of images to create the perception of three-dimensions, or the optics of optical devices such as telescopes, handheld binoculars, microscopes and the like.

Specifically, the inventor has conceived of techniques and apparatuses to simulate a three-dimensional effect when viewing an object, especially in situations in which only a two-dimensional image of the object is commonly made possible by various optical devices. The scenarios where only two-dimensional viewing is commonly available are where an object is very far from the viewing device (also referred to as the object being at infinity focus), or when viewing a two-dimensional object, such as an image on a surface, or an object on a microscope slide, among several other similar situations, where the eyes or the brain of a user cannot perceive the depth of the object. The depth of an object also includes the dimension of the object along the general direction of the light coming from the object to an optical device using which the object is being viewed.

The embodiments of the invention shift at least a portion of the light incident on at least one of the eyepieces horizontally, that is, to the left or the right of a viewer's eyes, such that the images formed in the left eye and the right eye of the viewer are slightly different. Shifting a portion of the light incident on an eyepiece, that is, within the eyepiece's field of view, shifts the part of image corresponding to the shifted light portion horizontally, resulting in a modified field of view corresponding to the eyepiece. The light incident on the light-shifting device is shifted or displaced with respect to the path the incident light would have taken in the absence of the light-shifting device. Generally, the shifting or displacement of light does not relate to a change in focus of the optical device, although a composite light-shifting device and an objective optical component, such as a composite lens, can be incorporated in the optical device within the scope and spirt defined by the embodiments described herein. Thus, by shifting one or more portions of the light incident only on one eyepiece view, or shifting one or more portions of light incident on each of the eyepieces in horizontal directions, slightly different images corresponding to each of the two eyepieces' field of view, are formed in the corresponding two eyes. The difference in the images of the left eye and the right eye creates a perception of depth for the object being viewed, for example, the object corresponding to the portion of light shifted, which creates a spectacular enhancement in the visual quality of the object, as compared to the images formed without utilizing the embodiments herein.

Embodiments described herein are applicable to biocular viewing, that is, for viewing by both the left and the right eye simultaneously, such that the two eyes perceive at least a slight difference in the images formed in the respective eyes. Viewing images in the left and the right eye simultaneously is referred to as stereoscopic viewing, which may include viewing different images in each of the two eyes. Incorporating a biocular attachment for two-eye viewing in single objective optical devices is well known. Further, inserting additional optical modification devices in biocular devices, such as single objective optical devices having biocular attachments, or dual objective optical devices, such as binoculars, is generally well known. Embodiments of the invention may readily be incorporated in such biocular devices, by inserting light-shifting device(s) at desired positions in the light path of such biocular device, using known techniques. In some embodiments, the light-shifting device(s) are configured to be removable from the light path, and specifically, are removable and reinsertable by a viewer using the biocular device, which is achieved, for example by mounting the light-shifting device(s) on a removable and reinsertable platform, such as sliding carriers well known in the art. As an example, US Patent Application Number 2005/0254125, titled “Telescope power switch,” incorporated herein by reference in its entirety, describes sliding carriers 34, 35 which may carry, instead of a lens, a clear optical flat having the light-shifting device(s) mounted thereon, such that the light-shifting device(s) may be removed and reinserted from the light path of an eyepiece or its field of view, by a viewer. Such sliding carriers may be inserted in single objective devices such as telescopes, in either or both channels of the biocular attachments to single objective devices, or in either channels of dual objective devices, such as binoculars, among several other optical devices and configurations thereof, which will occur to those skilled in the art within the scope and spirit of the embodiments described herein.

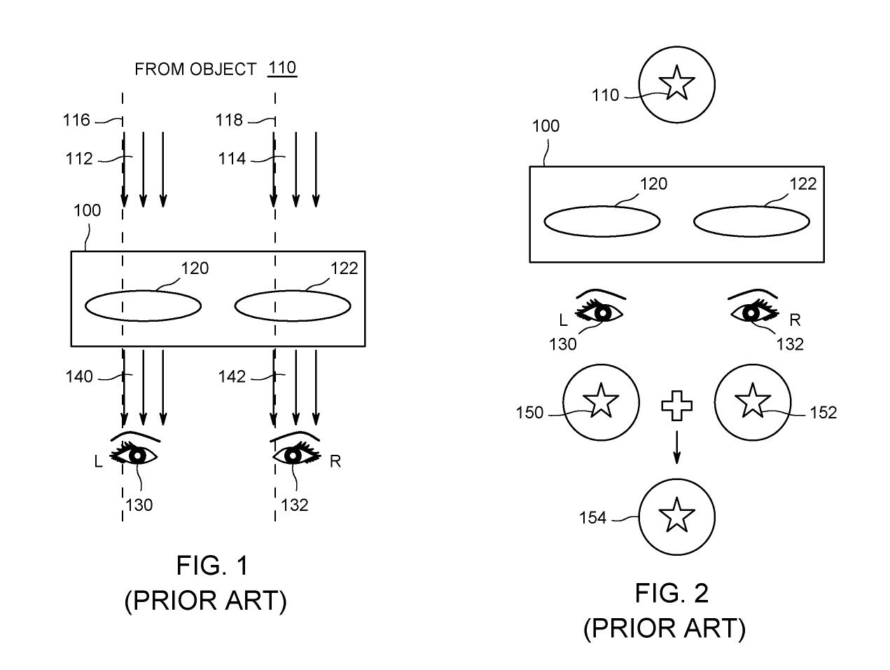

FIGS. 1 and 2 illustrate a conventional optical device 100 for viewing an object, where the optical device 100 processes light coming from the object 110 for eyes of a viewer. The optical device 100 is a biocular device that provides two viewing channels, one for each eye. The optical device 100 has optics (not shown) in each of the two channels, or has optics in a single channel and the incoming image is split into two channels, for example, by a beam-splitting prism configuration or any other known configuration to provide two-channel viewing, one for each eye. Apart from the optics, the optical device 100 comprises two eyepieces, a left eyepiece 120 and a right eyepiece 122, corresponding to a left eye 130 and a right eye 132, respectively. Light rays 112, 114 from the object 110 are processed by the optics of the optical device 100, and directed through the eyepieces 140, 142 to the eyes 130, 132, along unmodified light paths 116, 118, respectively.

For example, as shown in FIG. 2, the object 110 is a star, and is viewed by a single channel telescope having a biocular eyepiece attachment, the light passes through the two eyepieces 120, 122 to the eyes 130, 132 forming an identical image. That is, image 150 formed in the left eye 130 is identical to image 152 formed in the right eye 132. The perception of the viewer is a resultant image 154 that is two-dimensional. The star appears like an object drawn on a two-dimensional surface, similar to any other object (not shown) in the vicinity of the star in the image 154. As another example (not shown), an object, such as a bird located far away (i.e., at infinity) from an optical device, such as a handheld binocular having two telescope channels corresponding to each eye, processes light along each light path corresponding to the left eye 130 and the right eye 132. The resultant image would appear two-dimensional because the two different channels of the handheld binoculars would produce identical or nearly identical images in both eyes 130, 132. Such identical or nearly identical images in both eyes will result in an image that will not provide a perception of the depth of the bird's surroundings with respect to the bird, to the viewer. Therefore, for similar reasons discussed with respect to the example of a star as discussed above, the bird will seem like a ‘drawn’ image on the same surface as the surroundings of the bird, or in other words, the bird will appear two-dimensional. Other factors, such as angle of ambient light, movement of the bird or its surroundings may always play a part in the viewer knowing or perceiving that the bird is, in fact, three-dimensional.

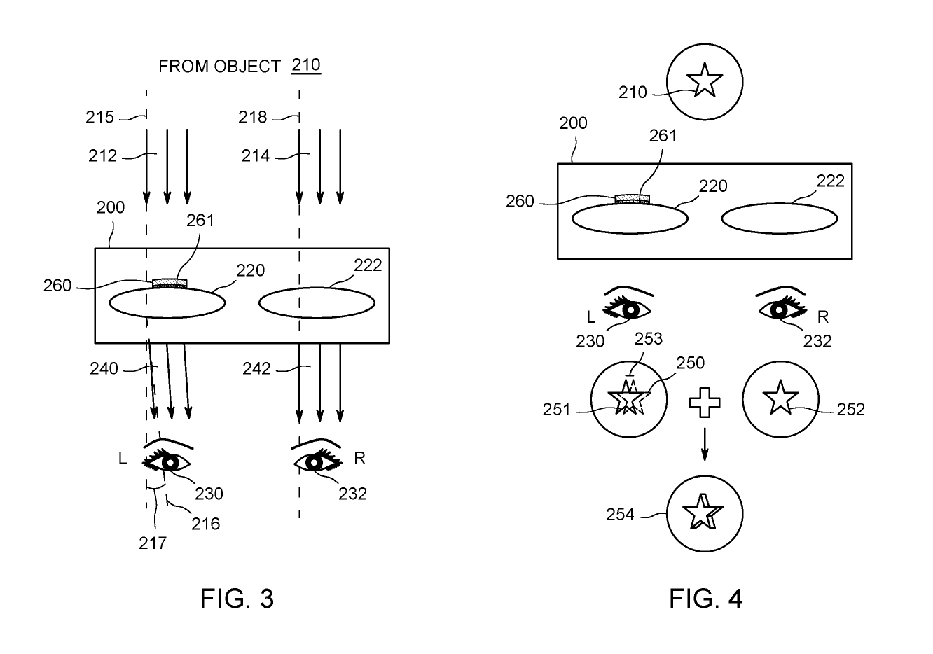

FIGS. 3 and 4 illustrate an optical device 200 for viewing an object 210 stereoscopically, where the optical device 200 processes light coming from the object 210 to eyes of a viewer, according to embodiments of the invention. The optical device 200 is a biocular device, and comprises a light-shifting device 260 positioned in a light path corresponding to the light entering a left eye or a right eye, or the light paths corresponding to both eyes. For the sake of simplifying explanation, FIGS. 3 and 4 illustrate the light-shifting device 260 positioned exclusively in a left light path 215, however, the light-shifting device may be positioned exclusively in a right light path 218, or both the left and the right light paths 215, 218.

Apart from the conventional and known optics relating to magnification of objects being viewed, the optical device 200 comprises two eyepieces, a left eyepiece 220 and a right eyepiece 222, corresponding to a left eye 230 and a right eye 232, respectively. The light-shifting device 260 is affixed to the left eyepiece 220 using an adhesive 261. In general, the light rays may be modified (i.e. shifted or displaced) by the adhesive 261 as well, unless the adhesive 261 has a negligible refractive index or a shape that does not cause shifting of the light (e.g. a cuboid having parallel entry and exit surfaces to the incident light). For the general discussion herein, the adhesive 261 is therefore included in the light-shifting device 260, unless otherwise mentioned or apparent from the context. Light rays 212, 214 from the object 210 are processed by the optics of the optical device 200, and resultant light rays 240, 242 respectively, are directed through the eyepieces 220, 222 to the eyes 230, 232. Specifically, a portion of light rays 212 along the left light path 215 are shifted (or displaced) horizontally by the light-shifting device 260 to a shifted left light path 216 to result in light rays 240, while the light rays 214 stay unmodified (i.e., not shifted) and along the right light path 218 to result in light rays 242. The modified left light path 216 is modified from the original left light path 215 by a shift angle 217. Therefore, a portion of an area within the field of view of the left eyepiece 220 is shifted by the light-shifting device 260 horizontally, while other areas in field of view of the left eyepiece 220 are not affected. For brevity of illustration, light rays 212 and 214 pertain to the object 210 only, and the light rays from the surrounding of the object 210 are not shown.

For example, as shown in FIG. 4, the object 210 is a star, and is viewed by a single channel objective telescope having a biocular eyepiece attachment. The light passes through the two eyepieces 220, 222 to the eyes 230, 232 forming different images. Image 250 (shown by a dashed line to indicate shifting or displacement) formed in the left eye 230 is different from image 252 formed in the right eye 232. Specifically, the image 250 is shifted in a horizontal direction from a position 251 where the image would have formed, had the left light path 215 not been modified by the light-shifting device 260 to the modified left light path 216. The shift between the image 250 and its unmodified position 251, indicated by numeral 253, corresponds to the shift angle 217, which corresponds to the refraction caused by the light-shifting device 260. Therefore, the image 250 formed in the left eye 230, though identical to the image 252 in every other sense, appears shifted, resulting in different images 250 and 252 being perceived by the brain. The shift 253 between the images 250 and 252, can be controlled by varying the shift angle 217, for example, by selecting and/or configuring the light-shifting device 260 as desired. The perception of the viewer is a resultant image 254 that appears three-dimensional, or ‘jumps out’ with respect to its surroundings, creating a perception of depth for the viewer. The resultant image 254 is not necessarily a three-dimensional image in reality, rather, the resultant image 254 is perceived as a three-dimensional image or an image in which the object 210 appears shifted toward the viewer as compared to the surroundings of the object 210, simulating a three-dimensional effect for the viewer.

It is theorized that the shifted images 251 and 252 are combined by a viewer's brain to create a three-dimensional representation image 254, which may likely be a result of the brain extrapolating or interpolating information that does not necessarily exist in the image, although such theorization is not intended to limit the present embodiments. However, the resultant image 254 generally appears better, for example, the object 210 in focus stands out in comparison to its surroundings, eyes may therefore focus better on such an object and glean off more details than in a case where the object 210 does not stand out, for example, in the absence of the embodiments described herein. As another example (not shown), an object, such as a bird located far away (i.e., at infinity) from an optical device, such as handheld binoculars having two telescope channels objectives corresponding to each eye, processes light along each light path corresponding to the left eye 230 and the right eye 232 in an identical fashion, except that portion of the image processed through the light-shifting device 260 corresponding to the left eye 230 is shifted horizontally by a desired amount compared to the same portion of the image in the right eye 232. The resultant image would appear three-dimensional in the sense described above, with respect to the position of the image shifted in the left eye 230 but not shifted in the right eye 232, because the two different channels of the handheld binoculars would produce slightly different images, the difference pertaining to the area affected by the light-shifting device 260, in the eyes 230, 232. Slightly shifted images in the eyes result in an image that provide a perception of the depth of the bird's surroundings with respect to the bird, and therefore, the bird will seem to ‘jump out’ as compared to the surroundings of the bird, or in other words, appear three-dimensional.

While “three-dimensional” may not be an accurate description of the observed phenomenon, the observed phenomenon does create an effect that is similar to viewing a three-dimensional image, and all references herein to a three-dimensional image or view, are made accordingly. A single channel telescope or a single objective telescope coupled to a biocular viewing attachment, a binocular having two channels or dual objective telescopes, can both benefit from the embodiments of the invention by incorporating the stereoscopic viewing device described herein, among several other optical devices having two viewing channels corresponding to the left eye and the right eye, as known in the art.

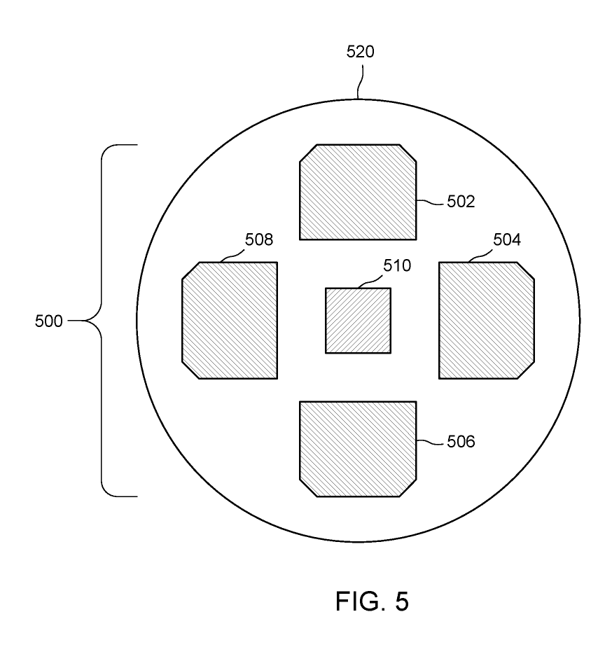

FIG. 5 illustrates a light shifting device 500 and an eyepiece 520, for example, similar to the left eyepiece 220 of FIG. 2. The light-shifting device 500 is composed of several light-shifting devices 502, 504, 506, 508 and 510. The light shifting devices 502-510 are positioned in the light path (perpendicular to the plane of the paper, not shown) of the eyepiece 520, generally in a direction from an object in the field of view of the eyepiece 520 and a viewer's eye. The hatching on the light-shifting devices 502-508 near the periphery are different from the hatching of the light-shifting device 510 at the center, and the different hatching in FIG. 5 illustrates a difference in the direction in which the light-shifting device 510 shifts the light along the light path, as compared to the light-shifting devices 502-508. The configuration of the light-shifting device 500 and the individual light shifting devices 502-510 therein shifts light path corresponding to the light coming from an object in the center of the view of the eyepiece corresponding to light-shifting device 510, in an opposite direction compared to shift in the light path corresponding to the light coming from the surroundings of the object corresponding to the light-shifting devices 502-508, the surroundings corresponding to the periphery of the eyepiece. The light-shifting is intended to be generally horizontal with respect to a viewer's eyes. It has been observed that such differential shifting of objects or regions within one image, which is combined with an unmodified image, for example, in a light path where no light-shifting devices are employed, creates an enhanced perception of a three-dimensional image compared to that described above with respect to FIGS. 3 and 4. The embodiment described in FIGS. 3 and 4 may be achieved, for example, by employing only one lighting device, for example, the light-shifting device 510.

The objects or region modified by the light-shifting devices 502-208 are perceived as being ‘farther away’ from the viewer, while the objects or region modified by the light-shifting device 510 ‘jump out’ at the viewer, creating an even more enhanced viewing experience of the object in the center of the eyepiece. The illustrated configuration of the light-shifting device 500 enhances the perceived distinction between the region corresponding to the center of the eyepiece 520 and the region corresponding to the periphery of the eyepiece 520. Different objects in a single image can be shifted differently by configuring the individual light-shifting devices 502-510 appropriately for example, by varying shapes, refractive indices, colors of the light-shifting devices, and the like, and several such configurations will occur readily to those skilled in the art according to the intended application of an optical device, without departing from the scope and spirit of the embodiments described herein.

In some embodiments, the eyepiece 520 may be a single lens or a composite eyepiece formed of several lenses as generally known in the art, and the various light-shifting devices 502-510 may be affixed to one lens of the eyepiece 520, or affixed in a distribution to multiple lenses of the eyepiece 520. Hereon, reference will be made to the eyepiece 520 and the lens(es) therein by the same reference numeral, unless indicated otherwise. In an embodiment, the light-shifting device(s) may be affixed to a platform other than the eyepiece 520, for example, an optical flat window located at an optimal position in relation to the eyepiece's 520 focal plane, on either the object side of eyepiece 520 or in an optical position with respect to the exit pupil facing the eye of the eyepiece 520.

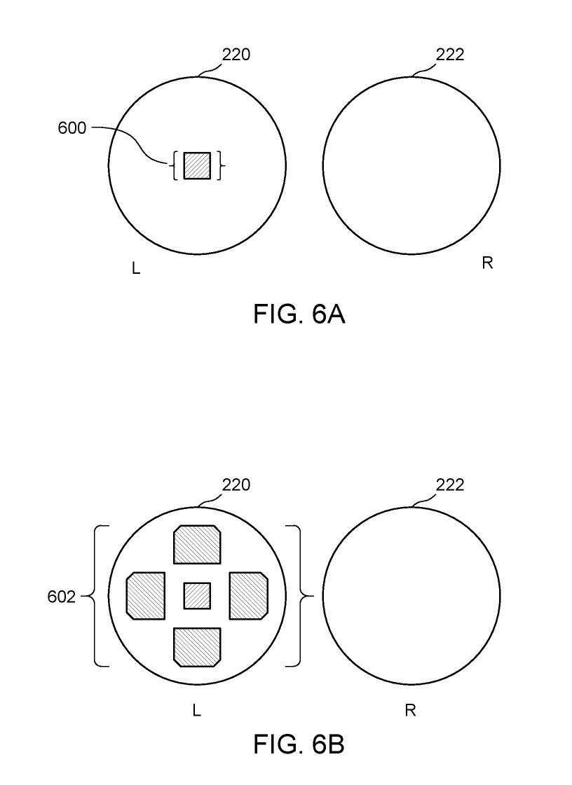

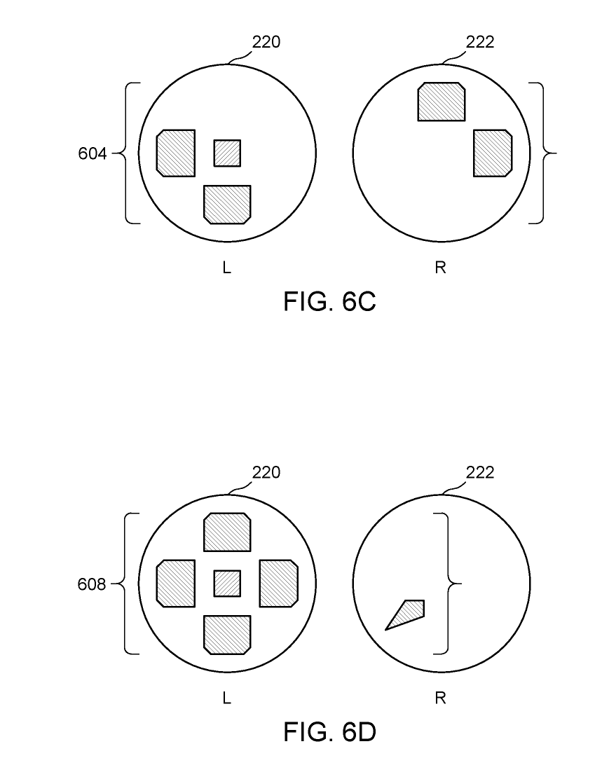

FIGS. 6A-D illustrate modification of light path corresponding to two eyepieces in a biocular device arrangement of FIGS. 3 and 4 using different light-shifting device configuration. FIG. 6A illustrates a light-shifting device 600 having a single light-shifting device aligned with the center of the eyepiece 220, and no light-shifting device in the light path of the eyepiece 222, similar to the light-shifting device 260 shown in FIGS. 3 and 4. FIG. 6B illustrates a light-shifting device 602 having multiple light-shifting devices in the light path of the eyepiece 220, and no light-shifting device in the light path of the eyepiece 222, similar to the light-shifting device 500 shown in FIG. 5. FIG. 6C illustrates a light-shifting device 604 having multiple light-shifting devices in the light path of both the eyepieces 220 and 222. The multiple light-shifting devices in the light-shifting device 604 have a similar arrangement as the light-shifting device 602, except that the multiple light-shifting devices are distributed in the light path of both eyepieces 220, 222 at a corresponding location. It is contemplated that the effect created by the light-shifting device 604 is similar to the effect created by the light-shifting device 602 of FIG. 6B. FIG. 6D illustrates a light-shifting device 604 having multiple light-shifting devices in the light path of both the eyepieces 220 and 222, where an individual light-shifting device in the right eyepiece 222 further creates an effect of pushing the corresponding region ‘farther away’ compared to the region in the center of the view. The light-shifting devices are configured to shift or displace the light in a generally horizontal direction with respect to a viewer's eyes or more particularly to the conventional optics of the optical device. Shifting or displacing light horizontally refers to shifting or displacing the light to the left or the right direction with respect to a viewer's eyes. Care is taken to avoid shifting or displacing the light in a vertical (up or down) direction with respect to a viewer's eyes, as vertical displacement has been observed to result in diplopia, or double vision.

Further, it has been observed that shifting light to right in the right eyepiece's field of view brings the image portion corresponding to the light displaced toward the outside of the field of view of the right eyepiece. This shifting or displacement toward the outside of the field of view makes the corresponding image portion appear to be farther away compared to the portions of the image that are not shifted or displaced. Further, shifting a portion of an image to the right in the left eyepiece's field of view brings such an image portion closer toward the center of the field of view of the left eyepiece, causing the image portion to appear to be closer to the portions of the image that are not shifted or displaced. The same effect is observed in combined fields of view of the left and the right eyepieces, wherein the portions of the image are displaced by light-shifting devices in either the left light path or the right ye path or both.

Accordingly, stereoscopic effect can be created in desired patterns by configuring the shape and position of the light-shifting devices. Similar stereoscopic effect can also be created by affixing a light-shifting device to the eyepiece using an adhesive with the same refractive index as the light-shifting device, in effect ‘blanking out’ the light-shifting properties of the light-shifting device where the adhesive is present. Specifically, in light-shifting devices such as a prism, the adhesive having the same refractive index as the prism can be used to form a shape complementing the shape of the prism, to form a resulting shape (e.g. a cuboid) which does not shift or displace incident light. In another embodiment where the adhesive has a refractive index different from the refractive index of the prism, then the combination of the prism and adhesive will still shift or displace incident light.

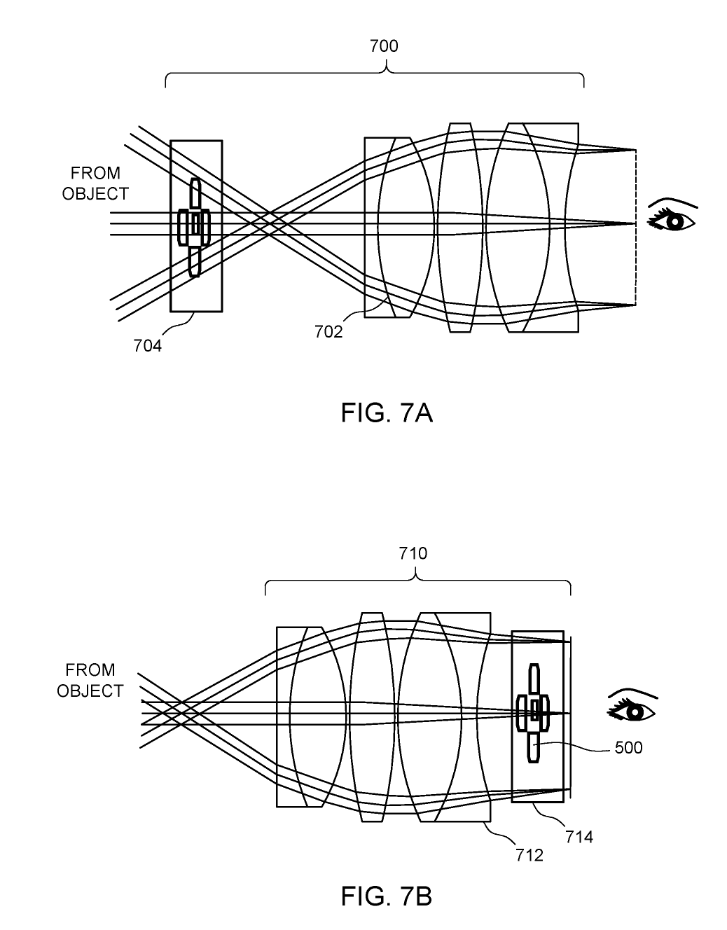

Further, light-shifting devices can be affixed to a platform or lenses that are a part of an eyepiece, or on platforms that are not a part of an eyepiece, for example, as illustrated by FIGS. 7A and 7B. FIG. 7A illustrates a modified erfler eyepiece 700 retrofitted with a light-shifting device, for example, the light-shifting device 500. The light-shifting device 500 is affixed to a platform 704 other than the lenses of a standard erfler eyepiece 702. FIG. 7B illustrates a modified erfler eyepiece 710 retrofitted with a light-shifting device, for example, the light-shifting device 500. The light-shifting device 500 is affixed to a platform 714 other than the lenses of a standard erfler eyepiece 712. The light-shifting device 500 can be placed on either side of an unmodified eyepiece, for example, as illustrated by the positions of the light-shifting device 500 affixed to platforms 704, 714 in FIGS. 7A and 7B, respectively. Further, the platforms 704, 714 may be a flat optical window, referred to as an optical flat. In some embodiments, the platforms 704, 714 are sliding carriers that are removable and reinsertable in the light path of the eyepiece 702, 712 respectively, for example, as discussed above and as generally known in the art.

Table 1 illustrates for retrofitting any biocular optical device with a stereoscopic viewing apparatus, according to embodiments of the invention.

TABLE 1

| | Method of retrofitting a biocular optical device |
|---|---|
| Step 1 | Provide a biocular optical device having a left and a right |
| | eyepiece |
| Step 2 | In at least one channel of the biocular optical device, |
| | insert or position at least one light-shifting device in at least |
| | one of a left light path or a right light path corresponding to the |
| | left eyepiece or the right eyepiece, respectively |
| | * The at least one light-shifting device can be positioned on |
| | a lens or a clear optical flat, the lens or the clear optical flat |
| | may be positioned in a permanent manner or a removable |
| | manner, and the at least one light-shifting device may be |
| | glued to the lens or the clear optical flat using an adhesive |
| | (e.g. a transparent adhesive), or using an |
| | electrostatic force applied to the light-shifting device. |

According to some embodiments, the eyepieces include at least one of a convex lens, a concave lens, an Erfler eyepiece, a Konig eyepiece, an orthoscopic eyepiece, a Kelner Eyepiece, a Plossl eyepiece, or Naglers eyepiece. According to some embodiments, light shifting device comprises at least one of a prism, a Fresnel prism, a lenticular array, a wedge prism, or an optical window having a portion of different refractive index compared to the rest of the optical window. According to some embodiments, the light-shifting device(s), in one or both eyes, are configured to shift or displace light by about 0.1 degrees to about 20 degrees horizontally. In some embodiments, the light is shifted or displaced by about 1.5 degrees to about 2.5 degrees horizontally. In some embodiments, the light is shifted or displaced by about 2 degrees horizontally. As used herein, shifting or displacing light refers to displacement of the portion of image corresponding to shifted or displaced light.

As used herein, “biocular” includes two viewing channels, and includes dual objective optical devices such as binoculars, and biocular viewing attachments coupled with single objective optical devices such as a telescope. Optics of an optical device refer to various optical apparatuses for creating desired magnification and light paths, for example, in a telescope, the lenses and mirrors. Further, stereoscopic dual objective optical device comprises handheld binoculars, mounted binoculars, dual tube telescopes, Newtonian binocular telescopes, or low power Huygenean binoculars, among several other optical devices known in the art.

In the optical art, objects that are too far away are generally referred to being at infinity, and the optics of the optical device is configured for infinity focus to view such devices. Light rays from such objects are illustrated by generally parallel rays, which is a matter of representation, and is not intended to limit the embodiments described herein. Drawings illustrate simplified light ray diagrams for brevity. The light rays, for example, shown in FIGS. 1-4, 7A and 7B are for illustrative purposes, however, the embodiments described herein are not limited to the light rays as illustrated in these drawings or associated theory.

Embodiments of the invention don't create an actual three-dimensional image of an object(s) being viewed, rather, the embodiments generate a perception of three-dimensions by shifting light in manner consistent with how the brain is theorized to experience depth perception.

Modifications to incorporate the embodiments described herein will occur readily to this skilled in the art, for example, application of the light-shifting devices to various optical devices to generate a stereoscopic view. While the present invention has been disclosed with reference to certain embodiments and variations, numerous other modifications, alterations and changes to the described embodiments are possible without departing from the sphere and scope of the present invention.

Accordingly, it is intended that the present invention not be limited to the described embodiments, but that it has the full scope defined by the above language, as shown in the figures, and as described in the claims which follow, as well as equivalents thereof.

1. A stereoscopic viewing apparatus comprising:
a left eyepiece corresponding to a left light path for viewing by a left eye, and right eyepiece corresponding to a right eye path for viewing by a right eye;
at least one light-shifting device positioned in at least one of the left light path or the right light path, wherein the at least one light-shifting device displaces light incident on at least one of the left eye or the right eye.

2. The apparatus of claim 1, wherein the at least one light-shifting device is positioned on the at least one of the left eyepiece or the right eyepiece.

3. The apparatus of claim 1, wherein the at least one light-shifting device is configured to displace light by about 0.1 degrees to about 20 degrees.

4. The apparatus of claim 3, wherein the at least one light-shifting device is configured to displace light by about 1.5 degrees to about 2.5 degrees.

5. The apparatus of claim 1, wherein the at least one light-shifting device comprises a first light-shifting device and a second light-shifting device, and wherein the first light-shifting device is configured to shift light in a different direction than the second light-shifting device.

6. The apparatus of claim 1, wherein the at least one light-shifting device comprises a first light-shifting device and a second light-shifting device, and wherein the first light-shifting device is positioned in the left eye path and the second light-shifting device is positioned in the right eye path.

7. The apparatus of claim 1, wherein the at least one light shifting device comprises at least one of a prism, a Fresnel prism, a lenticular array, a wedge prism, or an optical window having a portion of different refractive index compared to a refractive index of the rest of the optical window.

8. The apparatus of claim 1, wherein the at least one light shifting device is affixed to at least one eyepiece of the left eyepiece or the right eyepiece.

9. The apparatus of claim 1, wherein the at least one light-shifting device has a refractive index and is affixed to the at least one eyepiece using at least one of an adhesive having a refractive index that is substantially the same as the refractive index of the at least one light-shifting device, an adhesive having a refractive index different from the refractive index of the at least one light-shifting device, or an electrostatic force between the at least one light-shifting device and a component of the at least one eyepiece.

10. The apparatus of claim 1, wherein at least one eyepiece of the left eyepiece or the right eyepiece comprises at least one of a convex lens, a concave lens, an Erfler eyepiece, a Konig eyepiece, an orthoscopic eyepiece, a Kelner Eyepiece, a Plossl eyepiece, or a Naglers eyepiece.

11. The apparatus of claim 1, wherein the light-shifting device is positioned on a platform that is removable and reinsertable in the at least one light path.

12. The apparatus of claim 1, wherein the at least one light-shifting device is affixed to or formed on a platform which is not a part of the at least one eyepiece.

13. A method of retrofitting a biocular optical device with a stereoscopic viewing apparatus, the method comprising:
positioning at least one light-shifting device in at least one of a left light path or a right light path corresponding to a left eyepiece or a right eyepiece, respectively,
wherein the at least one light-shifting device displaces light passing through at least one of the left eyepiece or the right eyepiece.

14. The method of claim 13, wherein the positioning comprises positioning the at least one light-shifting device on the at least one eyepiece or on a clear optical flat which is not a part of the at least one eyepiece.

15. The method of claim 13, wherein the positioning comprises affixing the at least one light-shifting device on a component of the at least one eyepiece or a platform which is not a part of the at least one eyepiece.

16. The method of claim 15, wherein the affixing is effected by at least one of an adhesive or an electrostatic force applied to the at least one light-shifting device.

17. The method of claim 13, wherein the light-shifting device is positioned on a platform that is removable and reinsertable in the at least one light path.

18. A stereoscopic dual objective optical device having a left and a right channel, the stereoscopic dual objective optical device comprising:
a left eyepiece corresponding to a left light path for viewing by a left eye, and right eyepiece corresponding to a right eye path for viewing by a right eye;
at least one light-shifting device positioned in at least one of the left light path or the right light path, wherein the at least one light-shifting device displaces light incident on at least one of the left eye or the right eye, wherein the light-shifting device is positioned on a platform that is removable and reinsertable in the at least one light path.

19. The binocular of claim 18, wherein the at least one light-shifting device comprises at least one of a prism, a Fresnel prism, a lenticular array, a wedge prism, or an optical window having a portion of different refractive index compared to a refractive index of the rest of the optical window.

20. The stereoscopic dual objective optical device of claim 18, wherein the stereoscopic dual objective optical device comprises at least one of handheld binoculars, mounted binoculars, dual tube telescopes, Newtonian binocular telescopes, or low power Huygenean binoculars.
